(19) United States
(12) Patent Application Publication
(10) Pub. No.: US 2008/0067160 A1
(43) Pub. Date: Mar. 20, 2008

(54) SYSTEMS AND METHODS FOR LASER CUTTING OF MATERIALS

(76) Inventor: Jouni Suutarinen, Espoo (FI)

Correspondence Address: DUFT BORNSEN & FISHMAN, LLP, 1526 SPRUCE STREET, SUITE 302, BOULDER, CO, 80302, US

(21) Appl. No.: 11/531,996

(22) Filed: Sep. 14, 2006

(51) Int. Cl. B23K 26/12; B23K 26/38

(52) U.S. Cl. 219/121.86; 219/121.67

(57) ABSTRACT

A laser cutting system for cutting a material in a vacuum environment. The laser cutting system comprises a vacuum chamber adapted to house the material. The laser cutting system further comprises a vacuum system coupled to the vacuum chamber adapted to reduce the pressure inside the vacuum chamber below atmospheric pressure. The laser cutting system further comprises a laser system adapted to direct a laser beam onto the material inside the vacuum chamber to cut the material. The laser beam generates a plasma cloud near the material being cut. The laser cutting system further comprises a motion system adapted to control a relative position between the material and the laser beam. The reduction of pressure inside the vacuum chamber dissipates the plasma cloud near the material being cut faster than at atmospheric pressure.

### BACKGROUND OF THE INVENTION

1. Field of the Invention

The invention relates to laser cutting systems, and in particular, to laser cutting systems for cutting materials in a vacuum environment. The invention also relates to the field of laser singulation of semiconductor wafers. The invention also relates to the field of laser depaneling or singulation of printed circuit boards.

2. Statement of the Problem

It is known to manufacture semiconductors and printed circuit boards (“PCBs”) in a single wafer or panel using assembly equipment that manipulates the single wafer or panel to form multiple semiconductor dies or PCBs. This reduces the amount of time and equipment needed to produce the dies or PCBs.

Mass production of dies from a wafer requires that each die be singulated from the wafer before the individual dies can be used in electronic equipment. The time needed to singulate individual dies is an important factor in the economical production of integrated circuits using the singulated dies. It is desirable to reduce the time needed to singulate individual dies from a wafer.

Automated cutting or singulation systems are commonly used to cut individual dies from a wafer. Automated cutting systems often use saws and routers to sever the connections between the individual dies and the wafer. It is also known to singulate dies from a wafer using lasers.

Some lasers cut materials by vaporizing or melting the material using heat imparted into the material. Lasers offer advantages over mechanical singulation systems, such as lack of physical contact, higher precision, and minimal tool wear on cutting components. With mechanical sawing systems, saw blades may wear out rapidly. Dies are also more likely to chip or break when cut by mechanical singulation systems.

One problem encountered in singulating dies and PCBs using lasers is the excessive heating encountered immediately adjacent to the material the laser is cutting. New types of lasers reduce excessive heating using ultra short pulse lengths in the low picosecond and femtosecond range, rather than the more conventional nanosecond range. High speed lasers cut materials using adiabatic ablation in which chemical bonds of the materials are broken with high energy, rather than just melting the material. However, plasma shielding occurs when cutting some materials using high speed lasers. When laser pulses hit the material, there is a short plasma cloud generated that causes a plasma shielding effect. The plasma cloud tends to move upwards with a high velocity, but air resistance tends to stop the plasma cloud close to the material being cut. At high pulse repetition rates, the next pulse may hit the plasma cloud rather than the material. Thus, the pulse does not cut the material as effectively. Unfortunately, plasma shielding limits the repetition rate of the high speed lasers as well as the processing speed of the singulation system.

### SUMMARY OF THE SOLUTION

This invention solves the above and other problems with a laser cutting system that expedites the cutting of a material. The laser cutting system is adapted to cut a material housed inside a vacuum chamber. The pressure inside the vacuum chamber is lower than atmospheric pressure. The lowered pressure inside the vacuum chamber dissipates a plasma cloud generated by the laser beam faster than at atmospheric pressure. This allows the laser cutting system to use higher pulse repetition rate lasers, such as ultra short pulse lasers. This facilitates the cutting of materials faster than traditional laser cutting systems.

One exemplary embodiment of the invention is a laser cutting system for cutting a material using a vacuum chamber adapted to house a panel. The laser cutting system further comprises a vacuum system coupled to the vacuum chamber adapted to reduce the pressure inside the vacuum chamber below atmospheric pressure. The laser cutting system further comprises a laser system adapted to direct a laser beam onto the material inside the vacuum chamber to cut the material. The laser beam generates a plasma cloud near the material being cut. The laser cutting system further comprises a motion system adapted to control a relative position between the material and the laser beam. The reduction of pressure inside the vacuum chamber dissipates the plasma cloud near the material being cut faster than at atmospheric pressure.

A second exemplary embodiment of the invention is a laser cutting system for cutting a component panel. A component panel for example may include a wafer of semiconductors or a panel of printed circuit boards The second exemplary embodiment of the invention is similar to the first exemplary embodiment of the invention.

A third exemplary embodiment of the invention is a laser cutting system for cutting a component panel. The third exemplary embodiment of the invention is similar to the first exemplary embodiment of the invention. However, the third exemplary embodiment further comprises an interior area of the vacuum chamber approximately the size of the component panel with a side of the vacuum chamber comprising a transparent material. The laser system comprises an ultra short pulse laser adapted to direct a laser beam through the transparent material onto the component panel inside the vacuum chamber to cut the component panel. The cutting process involves adiabatic ablation rather than just melting the material in the wafer being cut. The laser system may further comprise a mirror adapted to redirect the laser beam from the ultra short pulse laser onto the component panel. The ultra short pulse laser may generate a plurality of laser beam pulses at a pulse repetition rate of about 1 MHz to about 20 MHz. A laser beam pulse during cutting generates a plasma cloud near the material being cut. The laser cutting system further comprises a vacuum system coupled to the vacuum chamber adapted to reduce the pressure inside the vacuum chamber below atmospheric pressure. The reduction in pressure helps to dissipate a plasma cloud generated by the pulse of the ultra short pulse laser near the component panel being cut before a subsequent pulse of the ultra short pulse laser reaches the component panel.

A fourth exemplary embodiment of the invention is a method for cutting a material using a laser. The method comprises housing a material in a vacuum chamber that reduces the pressure inside the vacuum chamber below atmospheric pressure. The method further comprises directing a laser beam onto the material inside the vacuum chamber to cut the material. The laser beam cutting the material generates a plasma cloud near the material being cut. Advantageously, the reduced pressure inside the vacuum chamber dissipates the plasma cloud fast enough to allow the laser cutting system to utilize faster pulse repetition lasers, such as ultra short pulse lasers. Thus, a plasma cloud generated by a pulse of the laser system will dissipate near the material being cut fast enough that a subsequent pulse of the laser system will hit the material rather than the plasma cloud.

The invention may include other exemplary embodiments described below.

### DESCRIPTION OF THE DRAWINGS

The same reference number represents the same element or the same type of element on all drawings.

FIG. 1 illustrates a laser cutting system for cutting a material in an exemplary embodiment of the invention.

FIG. 2 illustrates an overhead view of the laser cutting system as seen by the laser system in FIG. 1.

FIG. 3 is a flow chart illustrating a method for cutting a material in an exemplary embodiment of the invention.

FIG. 4 illustrates a plasma cloud generated when a pulse of the laser beam hits the material.

FIG. 5 illustrates the plasma cloud blocking a subsequent pulse of the laser beam from hitting the material.

FIG. 6 illustrates the plasma cloud dissipating near the material being cut before a subsequent pulse of the laser beam hits the material.

FIG. 7 illustrates a laser cutting system for cutting a wafer to form a plurality of dies in another exemplary embodiment of the invention.

FIG. 8 is a flow chart illustrating a method for cutting a wafer to form a plurality of dies in another exemplary embodiment of the invention.

### DETAILED DESCRIPTION OF THE INVENTION

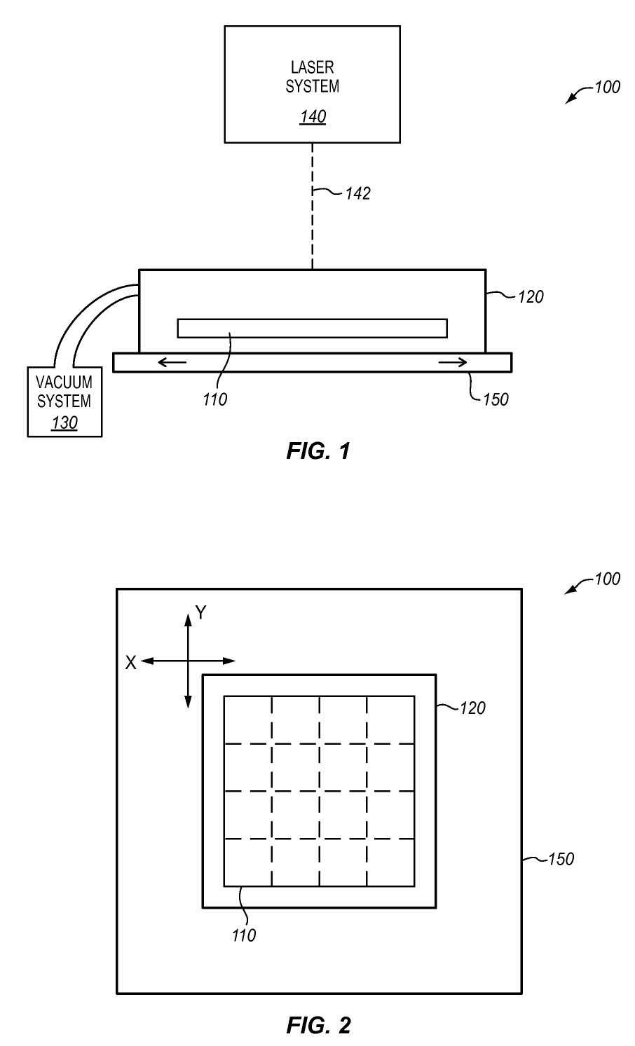

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a laser cutting system 100 for cutting a material 110 to form a plurality of PCBs in an exemplary embodiment of the invention. The term cutting may include scribing, dicing, scoring, trenching, grooving, singulating or depaneling material 110. Thus, laser cutting system 100 may be used to completely cut through material 110, or may be used to partially cut through material 110 to create grooves for use with additional cutting processes. The laser cutting system 100 may be adapted to cut any type of material 110. For example, material 110 may be a substrate, a wafer, a panel, a semiconductor, a printed circuit board or a polymer based flexible (flex) circuit. Material 110 may also be a component panel, which comprises a plurality of components used in electronics devices. A component panel may comprise for example, a wafer of dies or a panel of printed circuit boards. Laser cutting system 100 may include other systems or devices not shown in FIG. 1.

Laser cutting system 100 comprises a vacuum chamber 120 that may be any enclosure adapted to provide an airtight or substantially airtight seal around the material 110. Vacuum chamber 120 need not create a perfect vacuum, and may include vents for reducing the pressure inside the vacuum chamber 120.

Laser cutting system 100 further comprises a vacuum system 130 coupled to vacuum chamber 120. Vacuum system 130 may be a vacuum or any other system adapted to create suction and reduce the pressure inside the vacuum chamber 120 below atmospheric pressure.

Laser cutting system 100 further comprises a laser system 140 adapted to direct a laser beam 142 onto material 110. The cutting process using a high speed laser may involve adiabatic ablation in which the chemical bonds of the material 120 are broken with high energy imparted to material 110 by laser beam 142. Laser system 140 may generate a plurality of pulses with the time between pulses being determined by the pulse repetition rate of laser system 140. Laser system 140 may comprise a laser, as well as additional components and systems, such as mirrors, focusing lenses, etc. used to direct the laser beam 142 onto material 110.

Laser cutting system 100 additionally comprises a motion system 150 adapted to control a relative position between the material 110 and the laser beam 142. FIG. 2 illustrates an overhead view of laser cutting system 100 as seen by laser system 140 in FIG. 1. The X-Y motion system 150 for example may be a high accuracy X-Y gantry. Material 110 and vacuum chamber 120 may move with the motion system 150 along the X-axis and Y-axis in relation to laser system 140. Thus, laser beam 142 may remain stationary and continue cutting, scoring, or grooving material 110 as material 110 moves along the X-axis or Y-axis. Those of ordinary skill in the art will recognize that the position of material 110 may be controlled in relation to the laser beam in a variety of ways, including moving the laser system 140 in relation to the material 110, moving the laser beam 142 in relation to the material 110 using a series of mirrors, or moving the material within the vacuum chamber 120 using an X-Y gantry or other type of movement system mounted inside the vacuum chamber 120.

Exemplary cutting processes may include singulation of semiconductor dies from a wafer, depaneling of PCBs from a single panel, cutting or singulating other types of electronic circuits, etc. Those skilled in the art will recognize that a variety of materials may be cut, scribed, scored, grooved, trenched, depaneled or singulated using laser cutting system 100.

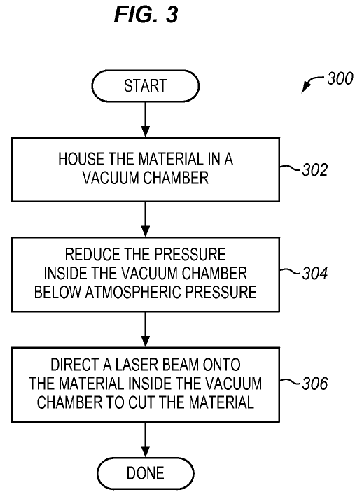

FIG. 3 is a flow chart illustrating a method 300 for cutting a material 110 in an exemplary embodiment of the invention. The steps of method 300 are described with reference to laser cutting system 100 in FIG. 1. The steps of the flow chart in FIG. 3 are not all-inclusive and may include other steps not shown.

In step 302, material 110 is housed inside vacuum chamber 120. Vacuum chamber 120 may include an opening on at least one side to load material 110 inside vacuum chamber 120.

In step 304, vacuum system 130 reduces the pressure inside vacuum chamber 120 below atmospheric pressure. Thus, vacuum system 130 creates a vacuum inside vacuum chamber 120. Vacuum system 130 may maintain suction inside vacuum chamber 120 throughout the entire cutting process.

In step 306, laser system 140 directs a laser beam 142 onto material 110 to cut material 110. For example, laser system 140 may direct laser beam 142 onto a wafer to form a plurality of semiconductor dies. Cutting the material 110 may include depaneling or singulating an individual piece or component from material 110, or may include scribing, scoring, trenching or grooving material 110. Exemplary individual pieces of material 110 may include a single PCB in a single panel, or a single die in a wafer. Score or scribe lines are then used as weak areas to separate the individual components from material 110 along the score lines. Breaking along the lines of perforation is then used to separate or singulate the individual pieces of material 110.

Laser system 140 may generate a plurality of laser beam 142 pulses to cut material 110. As a pulse hits material 110, laser beam 142 may generate a plasma cloud near material 110 being cut. The reduction in pressure inside the vacuum chamber 120 causes the plasma cloud to dissipate faster than at atmospheric pressure. Thus, the plasma cloud dissipates prior to a subsequent pulse of laser beam 142.

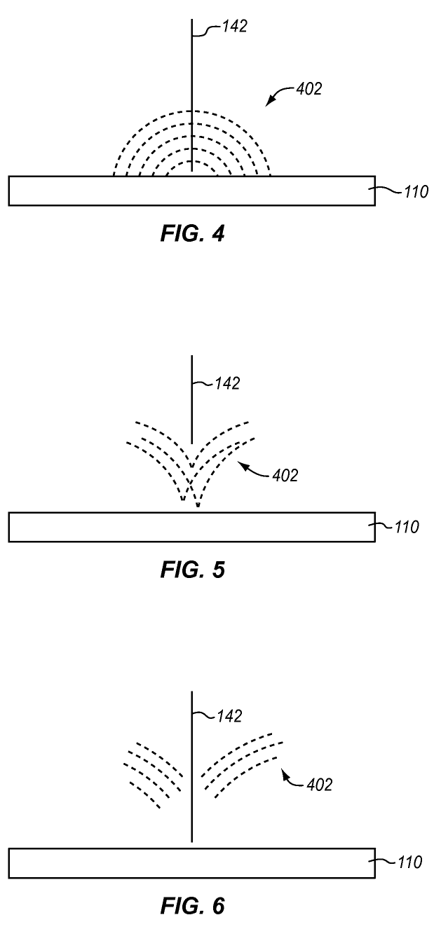

FIG. 4 illustrates a plasma cloud 402 generated when a pulse of laser beam 142 hits material 110. Some materials 110 cut by laser system 140 may generate a short plasma cloud 402 near the surface of material 110 being cut when a pulse of the laser beam 142 hits material 110. The cutting of material 110 may generate gaseous and particle debris near the surface of material 110 being cut. The plasma cloud 402 may remain near the surface being cut after the pulse, and may block a subsequent pulse from hitting material 110.

FIG. 5 illustrates plasma cloud 402 blocking a subsequent pulse of laser beam 142 from hitting material 110. Thus, if plasma cloud 402 does not dissipate fast enough near the surface being cut, a subsequent pulse of laser beam 142 may hit the plasma cloud 402 rather than material 110, and no cutting of material 110 may occur.

According to features and aspects of the invention, reducing the pressure in vacuum chamber 120 causes plasma cloud 402 to dissipate faster than at atmospheric pressure. The reduction in pressure inside vacuum chamber 120 removes air resistance which allows the plasma cloud 402 to move upwards at a higher velocity. Additionally, other gaseous debris generated by laser beam 142 hitting material 110 may dissipate near the surface being cut faster with the reduced pressure inside vacuum chamber 120. FIG. 6 illustrates plasma cloud 402 dissipating near the surface being cut before a subsequent pulse of laser beam 142 hits material 110. Thus, as illustrated in FIG. 6, laser beam 142 hits material 110 rather than plasma cloud 402, and is able to cut material 110.

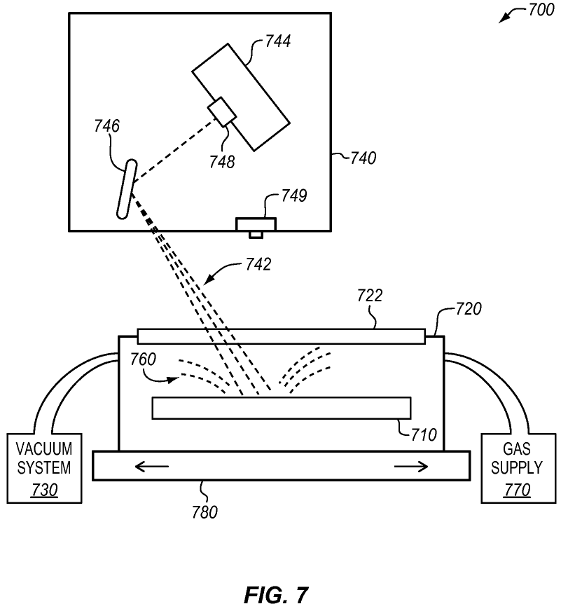

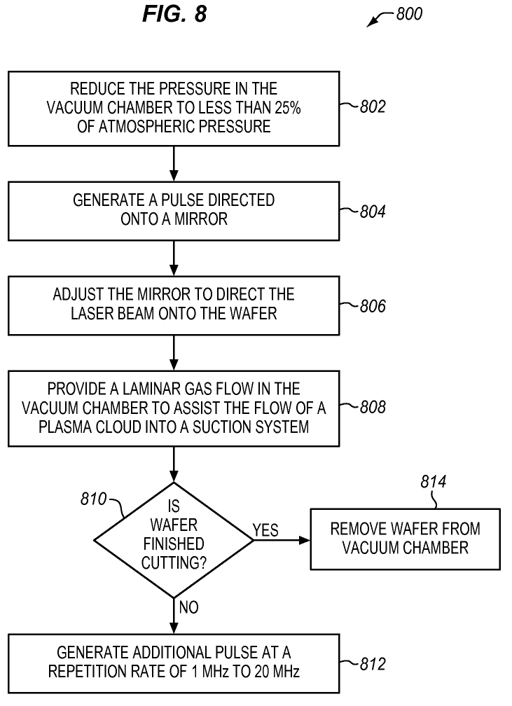

FIG. 7 illustrates a laser cutting system 700 for cutting a wafer 710 to form a plurality of dies in an exemplary embodiment of the invention. For example, laser cutting system 700 may be adapted for scribing, scoring, grooving, cutting, trenching, dicing or singulating a wafer 710. Laser cutting system 700 may be adapted to singulate other types of semiconductors or electrical circuits, such as PCBs from a single panel, polymer based flexible (flex) circuits, etc. Laser cutting system 700 may include other systems or devices not shown in FIG. 7.

Laser cutting system 700 comprises a vacuum chamber 720. The vacuum chamber 720 may be any enclosure adapted to create an airtight or substantially airtight seal around wafer 710 so that the pressure inside vacuum chamber 720 may be reduced below atmospheric pressure. Alternatively, vacuum chamber 720 may include events for reducing the pressure inside vacuum chamber 720. Vacuum chamber 720 may also include an opening on at least one side for loading a wafer 710 inside vacuum chamber 720. The vacuum created inside the vacuum chamber 720 allows for processing of toxic materials, such as Gallenium Arsenium in semiconductor wafers.

Laser cutting system 700 further comprises a vacuum system 730 coupled to the vacuum chamber 720. The vacuum system 730 may be a vacuum or any other system adapted to create and maintain reduced pressure inside vacuum chamber 720. The vacuum system 730 may be further adapted to remove process particles or gaseous debris from vacuum chamber 720.

Laser cutting system 700 further comprises a laser system 740. Laser system 740 comprises an ultra short pulse laser 744, and at least one mirror 746. The ultra short pulse laser 744 directs a laser beam 742 onto mirror 746, and mirror 746 redirects the laser beam 742 onto wafer 710 to cut a die from wafer 710. Laser system 740 may additionally comprise a camera 749 adapted to monitor the progress of the cutting process. Laser system 740 may optionally comprise additional components and systems, such as a series of mirrors 746, a focus lens, etc. At least one mirror 746 may be adjustable to redirect the laser beam 742 onto different portions of wafer 710.

Ultra short pulse laser 744 may generate a plurality of pulses to cut wafer 710. The time between the pulses is determined by the pulse repetition rate of ultra short pulse laser 744. For example, the pulse repetition rate of ultra short pulse laser 744 may be between about 1 MHz and about 20 MHz. Further, ultra short pulse laser 744 may be adjustable to generate laser beams 742 with varying properties. The adjustable properties may include wavelength, pulse length, maximum average output, etc. For instance, the maximum average output of the laser beam 742 generated by ultra short pulse laser 744 is dependant on the repetition rate and the pulse energy. For instance, if the pulse energy is 1 uJ and the repetition rate is 1 MHz, then the average power is 10 watts. Likewise, if the energy need is smaller, such as 0.5 uJ, and the repetition rate is 1 MHz, then the average power is only 5 watts. The average power for example may range for 1 watts to 80 watts. Ultra short pulse laser 744 may generate a laser beam 742 having various wavelengths. For instance, wavelengths of 1064 nm, 532 nm, 266 nm are typical in laser applications. However, the laser may be adjusted for example between a range of 266 nm and 1064 nm depending on the material being cut and the particular application of laser system 740. The pulse length may be less than 20 picoseconds (ps) to allow faster processing of panels 710. Short pulse widths are used so that the heat conduction of wafer 710 is low. With short pulse widths, there is almost no rise in material temperature near laser beam 742. This precludes a decrease in yield due to cracking caused by thermal strain produced by a rise in the temperature of the material.

Mirror 746 may be a system of mirrors or a piezo element for providing small high-speed movements of laser beam 742. Ultra short pulse laser 744 may direct a laser beam 742 onto mirror 746. Mirror 746 may be adjusted to re-direct laser beam 742 onto wafer 710. Thus, adjusting mirror 746 at different angles allows cutting of different areas of wafer 710 without moving ultra short pulse laser 744. Laser cutting system 700 may additionally comprise a motion system 780 adapted to control a relative position between the wafer 710 and the laser beam 742. The motion system 780 for example may be a high accuracy X-Y gantry to provide movement of vacuum chamber 720 and wafer 710 in both the X and Y directions under laser system 740.

A side of vacuum chamber 720 may comprise a transparent material 722. For example, transparent material 722 may be glass. Transparent material 722 allows a laser beam 742 to pass through transparent material 722 onto wafer 710. Additionally, the transparent material 722 restricts plasma cloud 760 generated by the laser beam 742 hitting wafer 710 from reaching laser lens 748 of ultra short pulse laser 744. Because plasma cloud 760 does not reach laser lens 748, it is not necessary to clean laser lens 748 as often.

Laser cutting system 700 further comprises a gas supply channel 770 coupled to vacuum chamber 720. Gas supply channel 770 provides a laminar gas flow in vacuum chamber 720 to assist the flow of plasma cloud 760 into vacuum system 730. Gas supply channel 770 may be any system or device capable of delivering a laminar gas flow through vacuum chamber 720. The laminar gas flow may comprise any type of gas capable of assisting the flow of plasma cloud 760 into vacuum system 730.

Assume a pulse of laser beam 742 hits wafer 710, generating a plasma cloud 760. If the pulse repetition rate of ultra short pulse laser 744 is too fast, then a subsequent pulse of laser beam 742 will strike plasma cloud 760 rather than wafer 710.

FIG. 8 is a flow chart illustrating a method 800 for cutting a wafer 710 to form a plurality of dies in an exemplary embodiment of the invention. The steps of method 800 will be described with reference to laser cutting system 700 in FIG. 7. The steps of the flow chart in FIG. 8 are not all-inclusive and may include other steps not shown.

In step 802, vacuum system 730 creates suction to reduce the pressure inside vacuum chamber 720 to less than 25% of atmospheric pressure. For example, vacuum system 730 may initially create suction when wafer 710 is placed inside vacuum chamber 720 to reduce the pressure inside vacuum chamber 720. Vacuum system 730 may additionally create suction during the entire cutting or scoring process.

In step 804, ultra short pulse laser 744 generates a laser beam 742 pulse directed onto mirror 746. In step 806, mirror 746 is adjusted to direct laser beam 742 onto wafer 710. For example, mirror 746 may be adjusted by a servo motor or any type of apparatus capable of high precision adjustments of mirror 746.

In step 808, gas supply channel 770 provides a laminar gas flow in vacuum chamber 720. The laminar gas flow assists the flow of plasma cloud 760 into vacuum system 730. As previously described, the reduction in pressure inside vacuum chamber 720 will cause plasma cloud 760 to dissipate near the material being cut faster than at atmospheric pressure. The laminar gas flow further speeds up the dissipation of plasma cloud 760, allowing the use of a high pulse repetition rate for ultra short pulse laser 744.

In step 810, laser cutting system 700 determines if ultra short pulse laser 744 has finished cutting wafer 710. The desired cutting may include scoring, depaneling, grooving or trenching wafer 710. For example, camera 749 may determine that the desired cut is complete. If ultra short pulse laser 744 is finished cutting wafer 710, then wafer 710 may be removed from vacuum chamber in step 814. Otherwise, in step 812, ultra short pulse laser 744 may generate an additional pulse, for example at a repetition rate of between 1 MHz to 4 MHz, and repeat step 806. If desired, the process may continue until laser beam 742 cuts partially or fully through wafer 710 as desired.

Although specific embodiments were described herein, the scope of the invention is not limited to those specific embodiments. The scope of the invention is defined by the following claims and any equivalents thereof.

I claim:

1. A laser cutting system for cutting a material, the laser cutting system comprising:
a vacuum chamber adapted to house the material;
a vacuum system coupled to the vacuum chamber adapted to reduce the pressure inside the vacuum chamber below atmospheric pressure;
a laser system adapted to direct a laser beam onto the material inside the vacuum chamber to cut the material, said laser beam generating a plasma cloud near the material being cut;
a motion system adapted to control a relative position between the material and the laser beam; and
wherein the reduction of pressure inside the vacuum chamber dissipates the plasma cloud near the material being cut faster than at atmospheric pressure.

2. The laser cutting system of claim 1 wherein the laser system comprises an ultra short pulse laser.

3. The laser cutting system of claim 1 wherein the material comprises a wafer, and the laser system is further adapted to cut the wafer to form a plurality of dies.

4. The laser cutting system of claim 1 wherein the material comprises a panel of printed circuit boards, and the laser system is further adapted to cut the panel to form individual printed circuit boards.

5. The laser cutting system of claim 1 wherein the laser system generates a plurality of pulses and the reduction in pressure substantially dissipates the plasma cloud generated by a pulse near the material being cut before a subsequent pulse of the laser reaches the material.

6. A laser cutting system for cutting a panel of components, the laser cutting system comprising:
a vacuum chamber adapted to house the component panel;
a vacuum system coupled to the vacuum chamber adapted to reduce the pressure inside the vacuum chamber below atmospheric pressure;
a laser system adapted to direct a laser beam onto the component panel inside the vacuum chamber to cut the component panel, said laser beam generating a plasma cloud near material being cut from the component panel;
a motion system adapted to control a relative position between the component panel and the laser beam; and
wherein the reduction of pressure inside the vacuum chamber dissipates the plasma cloud near the material being cut from the component panel faster than at atmospheric pressure.

7. The laser cutting system of claim 6 wherein the laser system comprises an ultra short pulse laser.

8. The laser cutting system of claim 7 wherein the laser system has a pulse repetition rate of about 1 MHz to about 20 MHz.

9. The laser cutting system of claim 6 wherein the laser system generates a plurality of pulses and the reduction in pressure substantially dissipates the plasma cloud generated by a pulse near the material being cut from the component panel before a subsequent pulse of the laser reaches the component panel.

10. The laser cutting system of claim 6 wherein an interior area of the vacuum chamber is approximately the size of the component panel.

11. The laser cutting system of claim 6 wherein a side of the vacuum chamber facing the laser system comprises a transparent material.

12. The laser cutting system of claim 6 further comprising:
a gas supply channel coupled to the vacuum chamber adapted to provide a laminar gas flow in the vacuum chamber to assist a flow of the plasma cloud into the vacuum system.

13. The laser cutting system of claim 6 wherein the vacuum system is adapted to reduce the pressure in the vacuum chamber to less than 25% of the atmospheric pressure.

14. The laser cutting system of claim 6 wherein the laser system is further adapted to direct the laser beam having the following properties:
a pulse length of less than 20 picoseconds; and
a repetition rate of about 1 MHz to about 20 MHz.

15. The laser cutting system of claim 6 wherein the laser system is further adapted to direct the laser beam having the following properties:
a maximum average power output greater than 1 Watt.

16. The laser cutting system of claim 6 wherein the laser system is further adapted to direct the laser beam having the following properties:
a wavelength of between about 266 nm to 1064 nm.

17. A laser cutting system for cutting a component panel, the laser cutting system comprising:
a vacuum chamber adapted to house the component panel with an interior area of the vacuum chamber being approximately the size of the component panel and a side of the vacuum chamber comprising a transparent material;
an ultra short pulse laser adapted to direct a laser beam through the transparent material onto the component panel inside the vacuum chamber, said pulses generating a plasma cloud near the material being cut;
a motion system adapted to control a relative position between the component panel and the laser beam; and
a vacuum system coupled to the vacuum chamber adapted to reduce the pressure inside the vacuum chamber below atmospheric pressure to dissipate a plasma cloud generated by a pulse of the ultra short pulse laser near the material being cut on the component panel before a subsequent pulse of the ultra short pulse laser reaches the component panel.

18. The laser cutting system of claim 17 further comprising:
a gas supply channel coupled to the vacuum chamber adapted to provide a laminar gas flow in the vacuum chamber to assist a flow of the plasma cloud into the vacuum system.

19. The laser cutting system of claim 17 wherein the vacuum system is adapted to reduce the pressure in the vacuum chamber to less than 25% of the atmospheric pressure.

20. The laser cutting system of claim 17 wherein the ultra short pulse laser is further adapted to direct the laser beam having the following properties:
a pulse length of less than 20 picoseconds; and
a wavelength of between about 266 nm and about 1064 nm.

21. A method for laser cutting of a material, the method comprising:
housing the material in a vacuum chamber;
reducing the pressure inside the vacuum chamber below atmospheric pressure;
directing a laser beam onto the material inside the vacuum chamber to cut the material, wherein the cutting of the material generates a plasma cloud near the material; and
wherein the reduction of pressure inside the vacuum chamber dissipates the plasma cloud near the material faster than at atmospheric pressure.

22. The method of claim 21 wherein the directing step further comprises:
generating a plurality of pulses of the laser beam at a pulse repetition rate of about 1 MHz to about 20 MHz.

23. The method of claim 21 wherein the material comprises a wafer, and the directing step further comprises:
directing the laser beam onto the wafer to cut a plurality of dies from the wafer.

24. The method of claim 21 wherein the material comprises a panel of printed circuit boards, and the directing step further comprises:
directing the laser beam onto the panel to cut a plurality of printed circuit boards from the panel.

25. The method of claim 21 further comprising:
providing a laminar gas flow in the vacuum chamber to assist a flow of a plasma cloud generated by the laser beam near the material being cut into a vacuum system.

26. The method of claim 21 wherein the reducing step further comprises:
reducing the pressure in the vacuum chamber to less than 25% of the atmospheric pressure.

27. The method of claim 21 wherein the directing step further comprises:
generating the laser beam with a pulse length of less than 20 picoseconds and a pulse repetition rate of about 1 MHz to about 20 MHz.
